(19) United States
(12) Patent Application Publication
(10) Pub. No.: US 2024/0074003 A1
(43) Pub. Date: Feb. 29, 2024

(54) HAND WARMING DEVICE

(71) Applicant: Shenzhen Senyuesheng Technology Co., Ltd., Shenzhen (CN)

(72) Inventor: Meifang XIAO, Shenzhen (CN)

(21) Appl. No.: 17/940,014

(22) Filed: Sep. 8, 2022

(30) Foreign Application Priority Data
Aug. 25, 2022 (CN) 202222253244.3

(51) Int. Cl. H05B 3/06; H05B 1/02

(52) U.S. Cl. CPC H05B 3/06; H05B 1/0252; H05B 2203/007

(57) ABSTRACT

A hand warming device includes a housing, a heating control circuit received in the housing including a front housing and a back housing connected with the front housing, a heat conducting member surrounding around the housing, a heat generating member clamped between the housing and the heat conducting member, and a temperature sensor. The heat generating member horizontally wraps on a right side and/or a left side of the front and back housings; correspondingly, the heat conducting member horizontally wraps on the right side and/or the left side of the front and hack housings. After the heat conducting member is arranged on the front and back housings, the heat conducting member covers on and abuts against the heat generating member. Both the heat generating member and the heat conducting member of the present disclosure are arranged around the left and right sides of the housing to improve heating effect.

### BACKGROUND

### 1. Technical Field

The present disclosure generally relates to the technical field of hand warming equipments, and especially relates to a hand warming device.

### 2. Description of Related Art

A hand warmer is a kind of automatic heating and portable product, which can be used indoors or outdoors. A heating circuit is set inside the hand warmer and connected with a heat generating member, and a heat conducting member is arranged outside the hand warmer and in contact with the heat generating member so that heat generated by the heat generating member is conducted and dissipated through the heat conducting member, and then hands of a person can touch or hold the heat conducting member for warming the hands, which is particularly suitable for being used in cold regions.

A conventional hand warmer generally includes a front shell and a rear shell, a heat conducting member covered by the front shell and the rear shell, and the heat generating member is sandwiched between the heat conducting member and the front shell, or the rear shell. Heat is generated by the heat generating member and then transmitted to the hand through the heat conducting member.

In the conventional hand warmer, the heat generating member and the heat conducting member are respectively arranged at a front side and a rear side of the hand warmer, and the front shell and the rear shell are long along front and rear surfaces thereof, and narrow along left and right sides thereof, in this way, when the hand holds the conventional hand warmer, it is generally held in the narrow part of the conventional hand warmer, that is, the left and right sides of the conventional hand warmer are held. However, in the conventional hand warmer, the left and right sides of the conventional hand warmer are positions where the front shell and the rear shell are connected and transited, which are far away from the heat generating member, so there is basically no heat at this place. As a result, when users hold the left and right sides of the conventional hand warmer, there is no heat at a position of palms of users', resulting in poor heating effect.

Therefore, a new hand warming device should be developed in order to solve the problems shown above.

### SUMMARY

The technical problems to be solved: in view of the shortcomings of the related art, the present disclosure provides a hand warming device which can improve a heating effect and conveniently hold the hand warming device by arranging a heat generating member and a heat conducting member around left and right sides of a housing thereof.

The technical solution adopted for solving technical problems of the present disclosure is:
A hand warming device includes a housing, a heating control circuit received in the housing, a heat conducting member surrounding around an outer surface of the housing, a heat generating member clamped between the housing and the heat conducting member, and a temperature sensor, both the heat generating member and the temperature sensor electrically connected to the heating control circuit;
the housing including a front housing and a back housing connected, with the front housing, wherein a side of the front housing and the back housing along a length direction of the housing is a right side, and a left side opposite to the right side, the heat generating member horizontally wrapped on the right side of the front housing and the back housing and/or horizontally wrapped on the left side of the front housing and the back housing;
correspondingly, the heat conducting member horizontally wrapped on the right side of the front housing and the back housing and/or horizontally wrapped on the left side of the front housing and the back housing, and when the heat conducting member is arranged on the front housing and the back housing, the heat conducting member covering on the heat generating member and abutting against the heat generating member.

Wherein the heat generating member includes a first heat generating member and a second heat generating member, the first heat generating member horizontally surrounding the left side of the front housing and the back housing and spanning a left connection of the front housing and the back housing, and the second heat generating member horizontally surrounding the right side of the front housing and the back housing and spanning a right connection of the front housing and the back housing;
correspondingly, the heat conducting member including a first heat conducting member and a second heat conducting member, the first heat conducting member horizontally surrounding the left side of the front housing and the back housing and spanning the left connection of the front housing and the back housing, and the second heat conducting member horizontally surrounding the right side of the front housing and the back housing and spanning the right connection of the front housing and the back housing, the first heat conducting member covering on the first heat generating member and abutting against the first heat generating member, and the second heat conducting member covering on the second heat generating member and abutting against the second heat generating member.

Wherein a first positioning window horizontally surrounds from the left side of the front housing to the left side of the back housing, and a second positioning window horizontally surrounding from the right side of the front housing to the right side of the back housing, the first heat generating member mounted on the first positioning window, and the second heat generating member mounted on the second positioning window.

Wherein a third positioning window is arranged on an area that both the front housing and the back housing cover on the first positioning window, a fourth positioning window arranged on an area that both the front housing and the back housing cover on the second positioning window, the first heat conducting member installed in the third positioning window to cover on the first positioning window, and the second heat conducting member installed in the fourth positioning window to cover on the second positioning window.

Wherein when the first heat conducting member is installed in the third positioning window, an outer surface of the first heat conducting member is flush with an outer surface of the front housing and an outer surface of the back housing, and when the second heat conducting member is installed in the fourth positioning window, an outer surface of the second heat conducting member is flush with the outer surface of the front housing and the outer surface of the back housing.

Wherein each, of the front housing and the back housing includes a first sliding portion, and each of the first heat conducting member and the second heat conducting member includes a second sliding portion; and wherein
the first sliding portion is slidably engaged with the second sliding portion, so that both the first heat conducting member and the second heat conducting member are slidingly pushed into the front housing and the back housing or slid out of the front housing and the back housing.

Wherein the first sliding portion is a sliding groove arranged on the front housing, and the back housing, the second sliding portion is a protrusion arranged on the first heat conducting member and the second heat conducting member, and sliding in the sliding groove after the protrusion is engaged with the sliding groove.

Wherein the sliding groove includes a positioning groove with a horn shape arranged at a position where the protrusion slides in.

Wherein the heat conducting member is made of aluminum.

Wherein the heat generating member is made of a sheet-shaped flexible material.

Wherein the heat generating member is a PI flexible electrothermal film.

Wherein the third positioning window and the fourth positioning window are respectively recessed on the outer surface at the left side of the front housing and the outer surface at the right side of the back housing to form a first step surface, while each of the first positioning window and the second positioning window is recessed to form a second step surface corresponding to the first step surface.

Wherein the first step surface or the second step surface on the left and right, sides of the front housing and the back housing includes a plurality of wiring holes penetrating into the front housing and the back housing.

Wherein the second step surfaces on the left and right sides of the front housing, and the back housing are provided with high-temperature resistant foam, and inner surfaces of the first heat generating member and the second heat generating member are respectively pasted on corresponding high-temperature resistant foam.

Wherein the temperature sensor is pasted on the high-temperature resistant foam and is in contact with the inner surfaces of the first heat generating member and/or the inner surface of the second heat generating member.

Wherein the housing is further provided with a charging interface electrically connected with the heating control circuit.

Wherein the housing is further provided with a control switch electrically connected with the heating control circuit.

Wherein the housing is further provided with an LED signal lamp electrically connected with the heating control circuit.

It should be understood that within the scope of the present disclosure, the above technical features of the present disclosure and technical features specifically described in the following (such as embodiments of the present disclosure) can be combined with each other to form a new or preferred technical solution, which will not be described here one by one due to space limitations.

The present disclosure provides the advantages as below.

First, the structure of the present disclosure is provided that the heat generating member is arranged around the left and right sides of the housing instead of that the convention heat generating member is arranged around the front and back sides of the housing of the conventional hand warmer, so that the hand warming device can be held by the left and right sides of the housing during heating, which is convenient for holding the hand warming device and improves a grip feeling. At the same time, the heat transmitted by the heat generating member through the heat conducting member can be obtained by a palm of the hand, which increases a contact area between the hand and the heat conducting member and improves a heating effect thereof.

Second, claws of the conventional heating conducting member that need to be bent are canceled, because when the conventional heating conducting member is installed on the housing, the claws of the conventional heating conducting member need to be bent one by one so as to clamp the conventional, heating conducting member with the housing. However, the hand warming device of the present disclosure is provided with a sliding engagement structure between the heat conducting member and the housing. During installation, the sliding portions of the two parts are aligned with each other and then slid in to complete the installation, thereby the installation of the heat conducting member is convenient and fast, and an installation efficiency of the heat conducting member is improved. Moreover, since the present disclosure adopts a sliding-type installation and disassembly of the heat conducting member, which is very conveniently repair and disassembly the heat conducting member.

Third, the installation of the conventional heat generating member is that a worker selects an approximate position in the housing based on experience to place the heat generating member, and then presses the heat conducting member on the housing to compress the heat generating member that has been placed on the housing, which easily causes an installation position of the heat generating member to be reworked due to assembly deviation. However, the present disclosure can accurately and quickly position and install the heat generating member by setting the first and second positioning windows on the housing, that is, the heat generating member of the hand warming device of the present disclosure has special positioning windows for positioning and installing the heat generating member, which improves accuracy of the heat generating member to be installed and positioned.

Fourth, the temperature sensor of the conventional hand warmer is not in contact with the heat generating member, a receiving groove is set on the heat conducting member for receiving the temperature sensor therein to collect a temperature of the heat conducting member, in this way, in the related art, the temperature sensor directly abuts against the heat conducting member without being pasted and fixed, so it is easy to loosen, which is easy to cause inaccurate temperature measurement, and if the temperature measurement is not accurate, it is easy to cause scalding and other events, and potential safety hazards are occurred. However, in the present disclosure, the temperature sensor is directly fixed on the high-temperature resistant foam without being loosened, and inner walls of the heat generating member and the high-temperature resistant foam are firmly bonded, so that the temperature sensor on the high-temperature resistant foam can be firmly bonded with the heat generating member to ensure the accuracy of temperature measurement and improve a safety of the hand warming device.

### BRIEF DESCRIPTION OF THE DRAWINGS

In order to more clearly understand the technical solution hereinafter in embodiments of the present disclosure, a brief description to the drawings used in detailed description of embodiments hereinafter is provided thereof. Obviously, the drawings described below are some embodiments of the present disclosure, for one of ordinary skill in the related art, other drawings can be obtained according to the drawings below on the premise of no creative work.

FIG. 1 is a schematic view of a hand warming device in accordance with an embodiment of the present disclosure.

FIG. 2 is similar to FIG. 1, but shown from another view.

FIG. 3 is a cross section view of the hand warming device of FIG. 1.

FIG. 4 is an enlarged view of circle A of FIG. 3.

FIG. 5 is an exploded, schematic view of the hand warming device of FIG. 1.

FIG. 6 is a circuit diagram of the hand warming device of FIG. 1.

FIG. 7 is another exploded, schematic view of the hand warming device of FIG. 1.

FIG. 8 is a schematic view of a positioning window for a heat generating member and a positioning window for a heat conducting member respectively set on a left side and a right side of a housing of the hand warming device of FIG. 1.

FIG. 9 is a schematic view of the positioning window for the heat generating member and the positioning window for the heat conducting, member respectively surrounding a front housing and a back housing of the hand warming device of FIG. 1.

FIG. 10 is an exploded, schematic view of the front housing and the back housing of the hand warming device of FIG. 9.

FIG. 11 is a schematic view of the front housing of the hand warming device of FIG. 9.

FIG. 12 is an enlarged view of circle B of FIG. 11.

FIG. 13 is a schematic view of a first heat conducting member of the hand warming device of FIG. 1.

FIG. 14 is a schematic view before the first heat conducting member is installed on the housing.

FIG. 15 is a schematic view that the first heat conducting member is pushed upward and installed in the housing.

FIG. 16 is a schematic view of the hand warming device of FIG. 1, shown a temperature sensor set in the hand warming device.

FIG. 17 is an enlarged view of circle C of FIG. 16.

The member labels according to the exemplary embodiment of the present disclosure shown as below:
100 hand warming device, 1 housing, 11 front housing, 111 outer surface, 12 back housing, 121 outer surface, 13 first sliding portion, 131 sliding groove, 132 positioning groove, 101 first positioning window, 102 second positioning window, 103 third positioning window, 104 fourth positioning window, 105 wiring hole, 106 wire receiving room, 107 second step surface 108 first step surface, 2 heating control circuit, 21 main control unit, 22 battery, 3 heat conducting member, 31 first heat conducting member, 311 outer surface, 32 second heat conducting member, 321 outer surface, 33 second sliding portion. 331 protrusion, 4 heat generating member, 41 first heat generating member, 42 second heat generating member, 5 high-temperature resistant foam, 51 first high-temperature-resistance foam, 52 second high-temperature-resistance foam, 6 temperature sensor, 61 wire, 7 charging interface, 8 control switch, 9 LED signal lamp.

### DETAILED DESCRIPTION

Reference will now be made in detail to embodiments, examples of which, are illustrated in the accompanying drawings. In the following detailed description, numerous specific details are set forth in order to provide a thorough understanding of the subject matter presented herein. Obviously, the implementation embodiment in the description is a part of the present disclosure implementation examples, rather than the implementation of all embodiments, examples. According to the described embodiment of the present disclosure, all other embodiments obtained by one of ordinary skill in the related art on the premise of no creative work are within the protection scope of the present disclosure.

In the description of the present disclosure, it needs to be explained that all the directional indicators (such as the terms: “upper”, “below”, “left”, “right”, “front”, “back” . . . ), are shown in the specification of the present disclosure. The indicated orientation or position of the terms shown in the detailed description is based on the orientation or position shown in the figures of the accompanying drawings of the present disclosure, which is only to easily simplify the description of the present disclosure, but not indicated that the devices or members of the present disclosure should have a particular orientation or should be designed and operated in a particular orientation. So the terms illustrated in the detail description are not by way of the limitation of the present disclosure.

Furthermore, in the description of the present disclosure, the terms such as “first” and “second” shown in the specification are only used to describe, but not indicated that the members of the present disclosure is important or represented the amount of the members. That is, the features limited by the terms of “first” and “second” may explicitly or implicitly include one or more features.

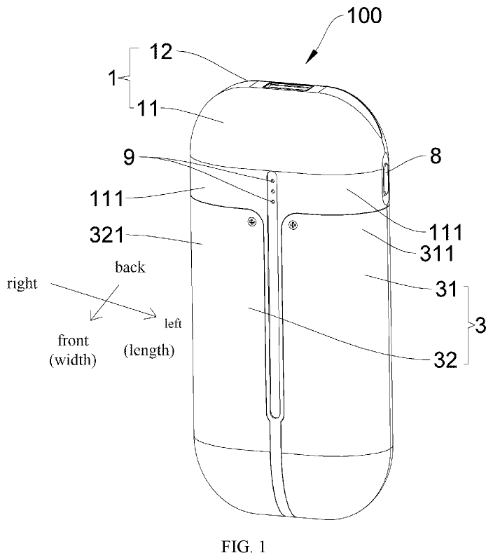

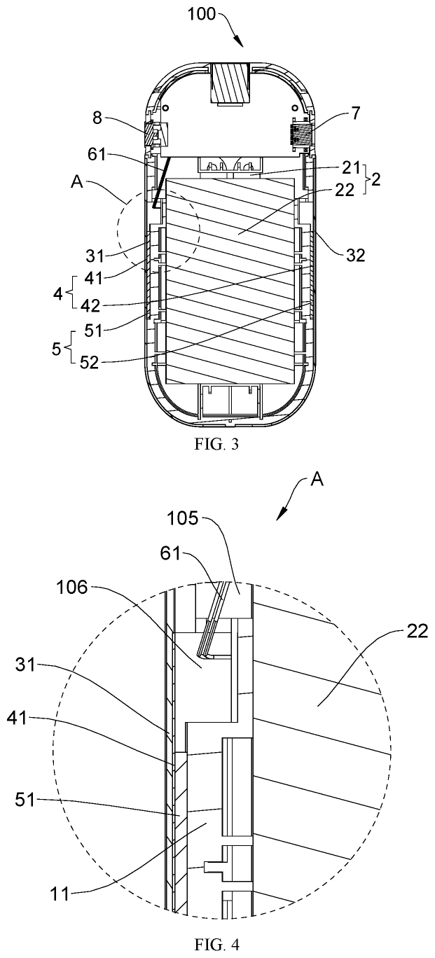

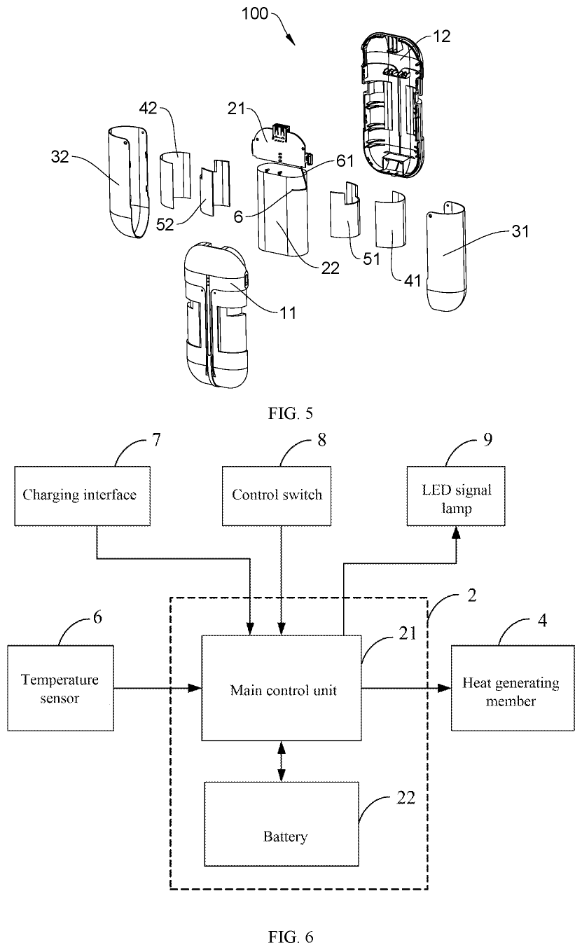

Referring to FIGS. 1-7, a hand warming device 100 in accordance with an embodiment of the present disclosure includes a housing 1, a heating control circuit 2 receiving in the housing 1, a heat conducting member 3 surrounding around an outer surface of the housing 1, a heat generating member 4 clamped between the housing 1 and the heat conducting member 3 and close to an inner wall of the heat conducting member 3, and a temperature sensor 6, both the heat generating member 4 and the temperature sensor 6 electrically connected to the heating control circuit 2. The temperature sensor 6 is attached to the heat conducting member 3 or the heat generating member 4 to sense a temperature of the heat conducting member 3 or the heat generating member 4. The heating control circuit 2 of the present disclosure includes a main control unit 21 and a battery 22 electrically connected to the main control unit 21. The main control unit 21 is arranged on a PCB and includes circuits such as a single chip microcomputer. The battery 22 supplies power to the main control unit 21 and the heat generating member 4, and the main control unit 21 controls to turn on or turn off the heat generating member 4 and adjust a power of the heat generating member 4. Heat generated by the heat generating member 4 is transmitted to hands of a person through the heat conducting member 3. The main control unit 21 is also configured to charge and discharge the battery 22.

In the present disclosure, the heat generating member 4 can be a member that can generate heat after being energized, such as a heating sheet or a heating wire. The heat conducting member 3 can be made of a metal material such as copper or aluminum, which has good heat conductivity. The hand warming device 100 of the present disclosure has at least one heat generating member 4, and correspondingly, there are at least one heat conducting member 3. Preferably, the heat conducting member 3 in the embodiment is made of aluminum that is light and has good heat conductivity.

The housing 1 of the present disclosure is a main frame of the hand warming device 100, in which the heating control circuit 2 is installed inside and both the heat generating member 4 and the heat conducting member 3 are installed outside. Preferably, the housing 1 of the embodiment of the present disclosure is made of high-temperature resistant plastic to reduce a total weight of the hand warming device 100. The housing 1 can be a single integrated housing or a separate structure combined by a front housing and a back housing, or a left housing and a right housing, or an upper housing and a lower housing.

Preferably, the housing 1 is further provided with a charging interface 7 electrically connected to the heating control circuit 2 and configured to connect an external power supply to charge the battery 22. The charging interface 7 can be a USB interface or a type-C interface.

Preferably, the housing 1 is further provided with a control switch 8 electrically connected to the heating control circuit 2 and configured to start and stop the heat generating member 4.

Preferably, the housing 1 is further provided with an LED signal lamp 9 electrically connected to the heating control circuit 2. The LED signal lamp 9 can be a combination of a plurality of LED lamps, such as a red LED, a Been LED and a yellow LED, which are configured to indicate a working state, a charging state or a power state, etc.

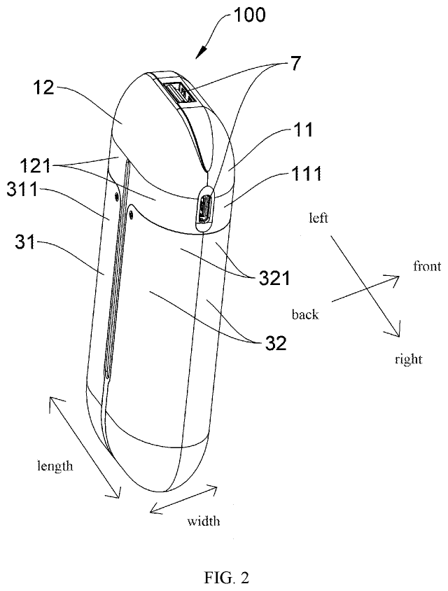

Referring to FIGS. 1-3, FIG. 5 and FIG. 7, the housing 1 includes a front housing 11 and a back housing 12 connected with the front housing 11, a side of the front housing 11 and the back, housing 12 along a length direction of the housing 1 is defined as a right side, and a side opposite to the right side is defined as a left side. Referring to FIG. 1 and FIG. 2, the hand warming device 100 is vertically placed, a direction extends along both sides of a width direction of the housing 1 is defined as a front and back direction of the housing 1, and a direction extends along both sides of a length direction of the housing 1 is defined as a left and right direction of the housing 1. Specifically, in the embodiment of the present disclosure, the front housing 11 is arranged on a front side of the housing 1, the back housing 12 is arranged on a back side of the housing 1, and the LED signal lamp 9 is arranged on the front housing 11. When a person stands in the same direction as the hand warming device 100, a right side of the person is the right side of the front housing 11 and the back housing 12, and a left side of the person is the left side of the front housing 11 and the back housing 12.

The heat generating member 4 of the present disclosure is horizontally wrapped on the right side of the front housing 11 and the back housing 12 and/or horizontally wrapped on the left side of the front housing 11 and the back housing 12. That is, the heat generating member 4 of the present disclosure is horizontally arranged around the right side of the housing 1, or horizontally arranged around the left side of the housing 1, or horizontally arranged around both left and right sides of the housing 1. At the same time, since the front housing 11 or the back housing 12 are connected and transited on the left and right sides, when the heat generating member 4 is horizontally arranged around the right side or the left side of the housing 1, the heat generating member 4 will span over a joint on the left side and the right side of the front housing 11 and the hack housing 12. A spanning arrangement of the heating generating member 4 means that one part of the heat generating member 4 is wrapped on the front housing 11 and the other part is wrapped on the back housing 12.

Correspondingly, the heat conducting member 3 is horizontally wrapped on the right side of the front housing 11 and the back housing 12 and/or horizontally wrapped on the left side of the front housing 11 and the back housing 12, and when the heat conducting member 3 is arranged on the front housing 11 and the back housing 12, the heat conducting member 3 covers on the heat generating member 4 and abuts against the heat generating member 4. That is, the heat conducting member 3 of the present disclosure is horizontally arranged around the right side of the housing 1, or horizontally arranged around the left side of the housing 1, or horizontally arranged around both left and right sides of the housing 1. The heat conducting member 3 is arranged according to the heat generating member 4. The heat conducting member 3 covers and abuts against the heat generating member 4. Therefore, if the heat generating member 4 is arranged on the right side of the housing 1, the heat conducting member 3 is also arranged on the right side of the housing 1 to cover on the heat generating member 4. If the heat generating member 4 is arranged on the left side of the housing 1, the heat conducting member 3 is also arranged on the left side of the housing 1 to cover on the heat generating member 4. If the heat generating members 4 are arranged on both the left side and the right side of the housing 1, the heat conducting members 3 are also arranged on the left and right sides of the housing 1 to cover on corresponding heat generating members 4 on the left and right sides.

In the present disclosure, a curve structure is formed at a connection joint between the left side and the right side between the front housing 11 and the back housing 12, so that both the heat generating member 4 and the heat conducting member 3 that horizontally cover on the front housing 11 and the back housing 12 are curved configuration. In the embodiment, the front housing 11 and the back housing 12 can be connected with each other by a plug way or a clamp way.

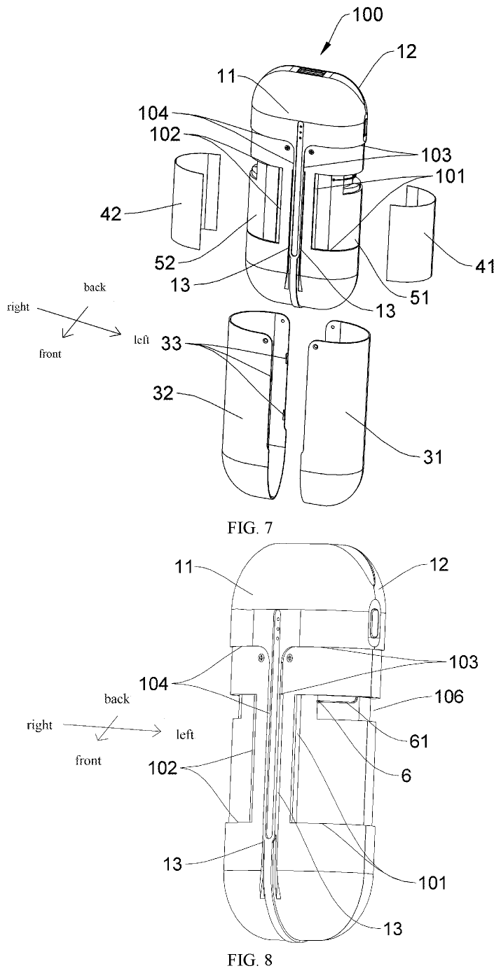

Referring to FIG. 1, FIG. 2 and FIG. 7, specifically, as an embodiment, the heat generating member 4 includes a first heat generating member 41 and a second heat generating member 42, the first heat generating member 41 horizontally surrounding the left side of the front housing 11 and the back housing 12 and spanning a left connection of the front housing 11 and the back housing 12, and the second heat generating member 42 horizontally surrounding the right side of the front housing 11 and the back housing 12 and spanning a right connection of the front housing 11 and the hack housing 12.

Correspondingly, the heat conducting member 3 includes a first heat conducting member 31 and a second heat conducting member 32, the first heat conducting member 31 horizontally surrounding the left side of the front housing 11 and the back housing 12 and spanning the left connection of the front housing 11 and the back housing 12, and the second heat conducting member 32 horizontally surrounding the right connection of the front housing 11 and the back housing 12 and spanning the right connection of the front housing 11 and the back housing 12, the first heat conducting member 31 covering on the first heat generating member 41 and abutting against the first heat generating member 41, and the second heat conducting member 32 covering on the second heat generating member 42 and abutting against the second heat generating member 42.

In the present disclosure, both the first heat conducting member 31 and the second heat conducting member 32 are the same structure and symmetrically arranged, and both the first heat generating member 41 and the second heat generating member 42 are the same structure and symmetrically arranged.

That is, in the embodiment of the present disclosure, the hand warming device 100 provides the first heat generating member 41 arranged on the left side of the housing 1, and the second heat generating member 42 arranged on the right side of the housing 1, and the first generating member 41 covers on the first heat conducting member 31, and the second generating member 42 covers on the second heat conducting member 32. The first heat generating member 41 and the first heat conducting member 31 span on the left side of the front housing 11 and the back housing 12, and the second heat generating member 42 and the second heat conducting member 32 span on the right side of the front housing 11 and the back housing 12.

The heat generating member 4 of the present disclosure is divided into two parts such as a left part and a right part, and the heat conducting member 3 is also divided into left and right parts, so that heat generated by the heat generating member 4 is transmitted from the left and right sides of the housing 1 to the two heat conducting members 3 on the left and right sides, and the two left and right heat conducting members 3 also cover on front and back surfaces of the housing 1. Thus, a heat transfer area of the whole hand warming device 100 is great and a heat utilization rate is high.

The advantages of the heat conducting member 3 of the embodiment adopting for horizontal wrapping around the front and back housings are as follows:
first, due to daily habits, when holding the hand warming device 100 by hands, it is customary to hold a narrow position of the housing, that is, a position that the left side of the front housing 11 and the back housing 12 connects with the right side of the front housing 11 and the back housing 12, that is, the position at the left and right sides of the entire housing. The heat conducting member 3 of the embodiment is a surrounding structure, it is convenient for an inner gripping surface of the palm to keep good contact with a surrounding surface of the heat conducting member 3 when a person's hand grips the left and right sides of the hand warming device 100, so that the palm can also directly contact the heat conducting member 3 to be heated. However, the conventional heat conducting member 3 is generally arranged on the front housing 11 and the back housing 12, separately, rather than adopting a surrounding arrangement, so that when the hand grips the left and right sides of the hand warming device 100, the palm can't be in contact with the heat conducting member 3, and when the hand attaches to front and back surfaces of the front housing 11 and the back housing 12 for being heated, it is inconvenient to hold the hand warming device. The heat conducting member 3 and the heat generating member 4 of the present disclosure are arranged to horizontally surround the left and right sides of the housing, which is not only convenient to hold the hand warming device, but also the palm can be in contact with the heat source well while holding the hand warming device, so as to improve the heating effect thereof, and at the same time, a horizontal surrounding design of the heat conducting member can improve the grip feeling thereof.

Second, since the palm can also be in contact with the heat conducting member 3, the heat conducting member 3 with the surrounding curved structure in the embodiment can increase the contact area between the palm and the heat conducting member 3 and can greatly improve a heat utilization rate of the heat conducting member 3 relative to the front and back non-surrounding type design, in the related art.

Preferably, referring to FIG. 2, the first heat conducting member 31 horizontally surrounds from a right half of the front housing 11 to a right half of the back housing 12, and the second heat conducting member 32 horizontally surrounds from a left half of the front housing 11 to a left half of the back housing 12, in this way, a front surface of the front housing 11 is basically covered by the first heat conducting member 31 on the right half of the front housing 11 and the second heat conducting member 32 on the left half of the back housing 12, and a back surface of the front housing 11 is basically covered by the first heat conducting member 31 on the right half of the front housing 11 and the second heat conducting member 32 on the left half of the back housing 12, so that the left and the right, the front and the back of the housing 1 are almost completely covered, which greatly increases the contact area that the heat conducting member 3 transmits heat.

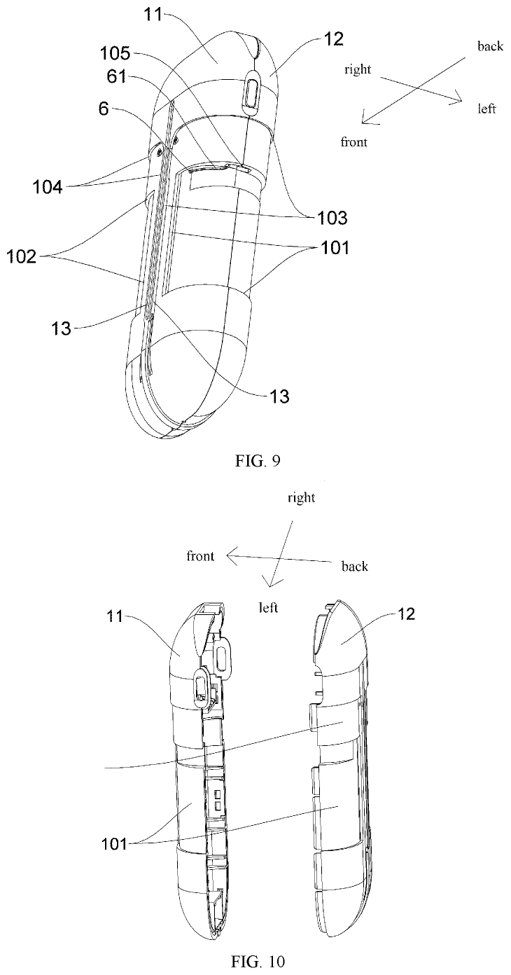

Continuing to refer to FIGS. 7-10, furthermore, a first positioning window 101 horizontally surrounds from the left side of the front housing 11 to the left side of the back housing 12, and a second positioning window 102 horizontally surrounds from the right side of the front housing 11 to the right side of the back housing 12, the first heat generating member 31 mounted on the first positioning window 101 and the second heat generating member 32 mounted on the second positioning window 102.

The first positioning window 101 and the second positioning window 102 play as a positioning function, when the first heat generating member 41 and the second heat generating member 42 are installed, which can quickly find an installation position on the housing 1, rather than the related art has no positioning structure on the front housing and the back housing, so that when installing the heat generating member, the worker only places the heat generating member at an approximate position on the front housing or the back housing by experience, and then covers the heat conducting member on the front housing or the back housing to clamp and fix the heat generating member. Since the heat generating member is placed by experience, it is easy to cause the position of the heat generating member to be misaligned and need to be reworked. Another function of the first positioning window 101 and the second positioning window 102 of the present disclosure is to install and fix the first heat generating member 41 and the second heat generating member 42 that can be fixed at the positioning windows by means of adhesive, screw fixation, etc. That is, when the heat generating member 4 of the present disclosure is installed, there are special positioning windows for positioning and installing the heat generating member 4, which improves accuracy of installation and positioning of the heat generating member 4.

Furthermore, a third positioning window 103 is arranged on an area that the front housing 11 and the hack housing 12 covers on the first positioning window 101, a fourth positioning window 104 arranged on an area that the front housing 11 and the back housing 12 covers on the second positioning, window 102, the first heat conducting, member 31 installed in the third positioning window 103 to cover on the first positioning window 103, and the second heat conducting member 32 installed in the fourth positioning window 104 to cover on the second positioning window 104.

Both the third positioning window 103 and the fourth positioning window 104 are arranged to enable special fixed positions for fixing the first heat conducting member 31 and the second heat conducting member 32 on the housing 1. At the same time, since both the third positioning window 103 and the fourth positioning window 104 are set on the housing 1, inner walls of the third positioning window 103 and the fourth positioning window 104 are lower than an outer surface of the housing 1, so that after the heat conducting member 3 is installed on the housing 1, the heat conducting member 3 will not protrude out of the outer surface of the housing 1 to affect the appearance thereof. At the same time, the third and fourth positioning windows are respectively stacked above the first and second positioning windows, and peripheral areas of the third and fourth positioning windows are larger than peripheral areas of the first and second positioning windows, which is equivalent to a partial overlap area between the third and fourth positioning windows and the first and second positioning windows, so that the third and fourth positioning windows cover on the first and second positioning windows. When the heat conducting member 3 is installed, the heat generating member 4 that has been installed at the first and second positioning windows is also covered by the heat conducting member 3, so that the heat generating member 4 can't expose to the outer surface of the housing 1 to further ensure safety without affecting the appearance thereof.

Preferably, referring to FIG. 1 and FIG. 2, when the first heat conducting member 31 is installed in the third positioning window 103, an outer surface 311 of the first heat conducting member 31 is flush with an outer surface 111 of the front housing 11 and an outer surface 121 of the back housing 12, and when the second heat conducting member 32 is installed in the fourth positioning window 104, an outer surface 321 of the second heat conducting member 32 is flush with the outer surface 111 of the front housing 11 and the outer surface 121 of the back housing 12. In this way, neither the first heat conducting member 31 and the second heat conducting member 32 protrude from the outer surface of the housing 1, nor are they lower than the outer surface, of the housing 1, so that the first heat conducting member 31, the second heat conducting member 32 and the housing 1 look like an integrated structure thereof, and the entire hand warming device 100 has a beautiful appearance. At the same time, the hand warming device 100 has a good touch feeling, and there are no projections or pits formed on the outer surface thereof.

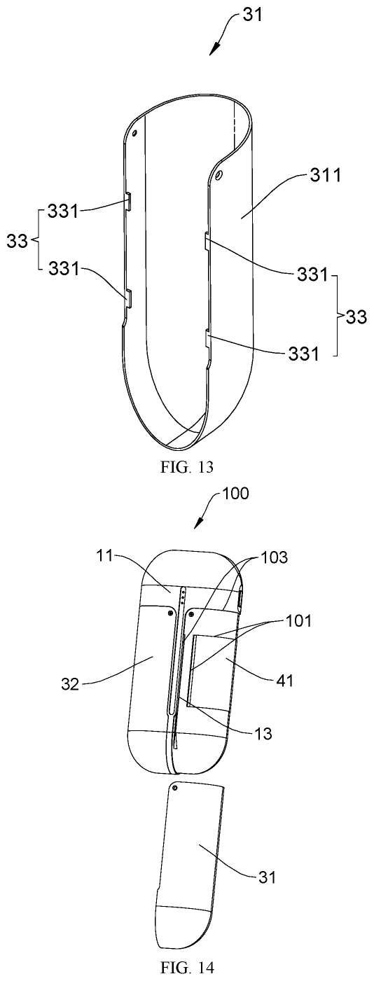

Referring to FIG. 7, FIG. 11 and FIG. 13, each of the front housing 11 and the back housing 12 includes a first sliding portion 13, and each of the first heat conducting member 31 and the second heat conducting member 32 includes a second sliding portion 33. The first sliding portion 13 is slidably engaged with the second sliding portion 33, so that both the first heat conducting member 31 and the second heat conducting member 32 are slidably pushed into the front housing 11 and the back housing 12 or slid out of the front housing 11 and the back housing 12. The heat conducting member 3 can slide relative to the housing 1 along an up and down direction or a left and right direction.

In the embodiment, of the present disclosure, the first sliding portions 13 are respectively arranged, on the right sides of the front housing 11 and the back housing 12, and the second sliding portions 33 are respectively arranged on the front and back sides of the first heat conducting member 31. The second sliding portion 33 on the front side of the first heat conducting member 31 is slidably engaged with the first sliding portion 13 on the right side of the front housing 11, and the second sliding portion 33 on the back side of the first heat conducting member 31 is slidably engaged with the first sliding portion 13 on the right side of the back housing 12. The left sides of the front housing 11 and the back housing 12 are respectively provided with the first sliding portion 13 the front and back sides of the second heat conducting member 32 are respectively provided with the second sliding portion 33, the second sliding portion 33 on the front side of the second heat conducting member 32 is slidably engaged with the first sliding portion 13 on the left side of the front housing 11, and the second sliding portion 33 on the back side of the second heat conducting member 32 is slidably engaged with the first sliding portion 13 on the left side of the back housing 12.

The first sliding portions 13 on both the front housing 11 and the back housing 12 and the second sliding portions 33 on both the first heat conducting member 31 and the second heat conducting member 32 are cooperated to not only enable that the first heat conducting member 31 and the second heat conducting member 32 can slide relative to the front housing 11 and the back housing 12 under an external force, but also enable that the first heat conducting member 31 and the second heat conducting member 32 are engaged and fixed to the front housing 11 and the back housing 12 without loosening and slipping after the external force is removed and the sliding therebetween stops.

Specifically, the first sliding portion 13 of the present disclosure is a sliding groove 131 arranged on the front housing 11 and the back housing 12, the second sliding portion 33 is a protrusion 331 arranged on the first heat conducting member 31 and the second heat conducting member 32. The protrusion 331 can slide in the sliding groove 131 after the protrusion 331 is engaged with the sliding groove 131. Referring to FIG. 8, the sliding groove 131 of the present disclosure is arranged at an edge position of a vertical side of the third positioning window 103 and the fourth positioning window 104.

The sliding groove 131 according to the embodiment of the present disclosure is provided on the front housing 11 and the back housing 12 along the up and down direction, and the protrusion 331 is also provided on the first heat conducting member 31 and the second heat conducting member 32 along the up and down direction, therefore, the first heat conducting member 31 and the second heat conducting member 32 slide relative to the front housing 11 and the back housing 12 along the up and down direction. A cooperation between the sliding groove 131 and the protrusion 331 is a clearance fit that can move relatively, when the first heat conducting member 31 and the second heat conducting member 32 are pushed or pulled by an external force, the protrusions 331 of the first heat conducting member 31 and the second heat conducting member 32 can slide in the sliding, groove 131 of the front housing 11 and the back housing 12 so that the first heat conducting member 31 and the second heat conducting member 32 can slide relative to the front housing 11 and the back housing 12. After the external force is removed, the protrusion 331 clamps with the sliding groove 131 under the clearance fit, so that the first heat conducting member 31 and the second heat conducting member 32 are fixed to the front housing 11 and the back housing 12.

The sliding grooves 131 on the front housing 11 and the back housing 12 are adapted to the protrusions 331 on the first heat conducting member 31 and the second heat conducting member 32. If the protrusions 331 of the present disclosure are provided on opposite sides of the first heat conducting member 31 and the second heat conducting member 32, the left and right sides of the front housing 11 and the back housing 12 are respectively provided with two sliding grooves 131 to slidably engage with the protrusions 331 on both sides of the first heat conducting member 31 or the second heat conducting member 32.

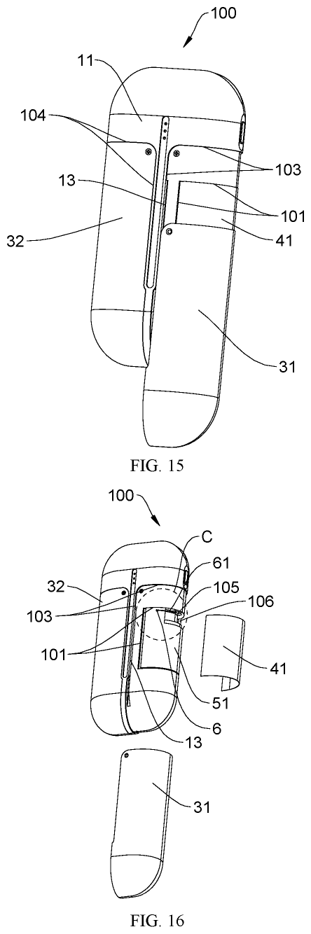

Since the heat conducting member 3 of the hand, warming device 100 of the present disclosure is installed in the housing 1 by a sliding engagement manner, it is very convenient to install the heat conducting member 3. For example, as shown in FIGS. 14-15, the first heat conducting member 31 starts from a lower part of the housing 1, and after the protrusion 331 of the first heat conducting member 31 is aligned with the sliding groove 131 of the housing 1, the first heat conducting member 31 is pushed upwardly, as shown in FIG. 15, the protrusion 331 of the first heat conducting member 31 continuously slides in the sliding groove 131 of the housing 1, and the first heat conducting member 31 is continued to be pushed until the first heat conducting member 31 is completely installed in the housing 1 to cover on the first heat generating member 41.

When the first heat conducting member 31 slides into the front housing 11 and the back housing 12 and is finally fixed at the third positioning window 103, the third positioning window 103 has a limiting effect on the first heat conducting member 31 to slide into the front housing 11 and the back housing 12, that is, when the first heat conducting member 31 is pushed until it can't be pushed, an edge of the first heat conducting member 31 just abuts against an edge of the third positioning window 103 and covers on the third positioning window 103. Similarly, when the second heat conducting member 31 slides into the front housing 11 and the back housing 12 and is finally fixed at the fourth positioning window 104, the fourth positioning window 104 has a limiting effect on the second heat conducting member 32 to slide into the front housing 11 and the back housing 12, that is, when the second heat conducting member 32 is pushed until it can't be pushed, an edge of the second heat conducting member 32 just abuts against an edge of the fourth positioning window 104 and covers on the fourth positioning window 104.

Since the sliding engagement structure of the present disclosure is adopted between the heat conducting member 3 and the housing 1, when the heat conducting member 3 is installed, it is only necessary to slide the heat conducting member 3 into the housing 1. Since the heat conducting member 3 of the hand warming device 100 eliminates the claws that need to be bent, the installation can be completed by aligning the heat conducting member 3 with the sliding portion of the housing 1 and then sliding the heat conducting, member 3 into the housing 1 to complete the entire installation thereof. However, in the conventional hand warming device, a plurality of flexible claws on the periphery of the heat conducting member is provided, when the heat conducting member is installed on the front housing or the back housing, the heat conducting member is first pressed on the outer surface of the front housing or the back housing, and then the claws of the heat conducting member are bent one by one to clamp the heat conducting member with the front housing or the back housing. In this way, when installing the heat conducting member on the housing, it is necessary to manually bend each claw in turn, which is very inconvenient, an installation time is long and efficiency is low. At the same time, the claw is easy to break after being bent for many times, so that the hand warming device is easy to damage the claw of the heat conducting member when repairing and disassembling the heat conducting member. Thirdly, the conventional heat conducting member is fixed by a claw assembly way, which easily leads to a deviation of the heat conducting member and the whole assembly is not in place.

In the present disclosure, after the sliding engagement structure is adopted between the heat conducting member 3 and the housing 1, it is not necessary to bend the claws of the heat conducting member 3 one by one, which is time-consuming and laborious and has low efficiency. The hand warming device 100 of the present disclosure is very convenient to install the heat conducting member 3 outside the housing 1, and since the present disclosure adopts the sliding type installation and disassembly of the heat conducting member 3, so that the hand warming device 100 is also very convenient to be repaired and disassembled.

A whole structure of the hand warming device 100 of the present disclosure has changed greatly relative to the conventional hand warming device. When installing the heat generating member 4, there is a special positioning window on the housing for positioning and installing the heat generating member 4, which improves the accuracy of the installation and positioning of the heat generating member 4. The heat conducting member 3 is installed by the special sliding engagement structure, which improves the installation efficiency of the heat conducting member 3. That is, in the embodiment of the present disclosure, both left and right sides of the housing 1 provide with first and second positioning windows and third and fourth positioning windows. The first positioning window 101 and the third positioning window 103 on the left side surround and span from the left side of the front housing 11 to the left side of the back housing 12, and the second positioning window 102 and the fourth positioning window 104 on the right side surround and span from the right side of the front housing 11 to the right side of the back housing 12, so that the first heat generating member 41 and the first heat conducting member 31 are installed around the left side of the front housing 11 and the back housing 12, and the second heat generating member 42 and the second heat conducting member 32 are installed around the right side of the front housing 11 and the back housing 12.

Preferably, after the heat conducting member 3 of the present disclosure is slidably mounted on the housing 1, which can be further fastened with screws.

It can be understood that in other embodiments, the heat conducting member 3 and the housing 1 can be fixed each other by adopting other engagement structures, such as a buckle connection and a plug connection, etc.

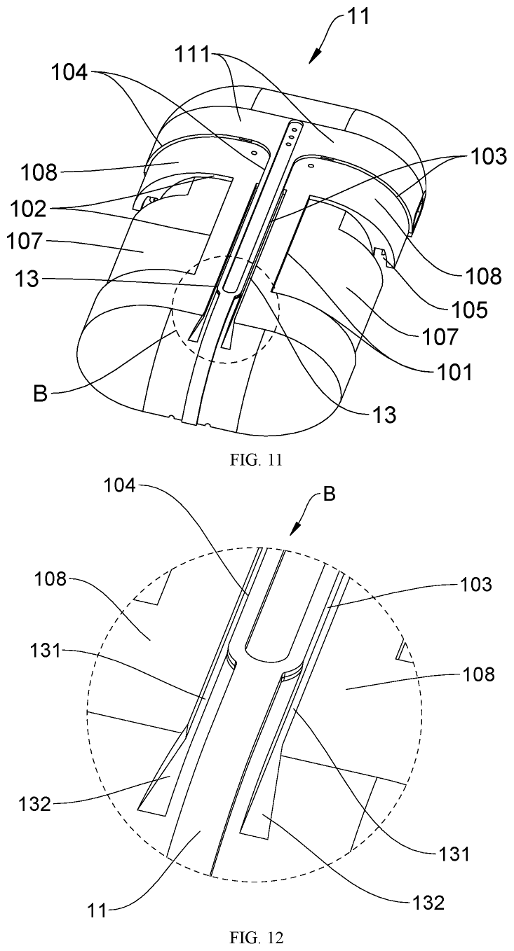

Furthermore, referring to FIG. 12, the sliding groove 131 includes a positioning groove 132 with a horn shape arranged at a position where the protrusion 331 slides in. The positioning groove 132 is an original position at which the protrusion 331 slides into the sliding groove 131, which can quickly align the protrusion 331 with the original position of the sliding groove 131, at the same time, the positioning groove 132 is a horn shape and a width of the positioning groove 132 is larger than that of the sliding groove 131, in this way, the protrusion 331 can be smoothly pushed into the sliding groove 131 to improve the installation efficiency thereof.

Preferably, the heat, generating member is made of a sheet-shaped flexible material, which can be installed on the first and second positioning windows that surround around the housing.

Furthermore, the heat generating member 4 of the present disclosure is a PI flexible electrothermal film that is taken polyimide film as an outer insulator, taken metal foil and metal wire as an inner conductive heat generator, and obtained by a heat bonded way under a high temperature and a high pressure. The PI flexible electrothermal film can adapt to be bent, and has good insulation and high heating efficiency.

Referring to FIG. 11, the third positioning window 103 and the fourth positioning window 104 are respectively recessed on the outer surface at the left side of the front housing 11 and the outer surface at the right side of the back housing 12 to form a first step surface 108, while each of the first positioning window 101 and the second positioning window 102 is recessed to form a second step surface 107 corresponding to the first step surface 108. The second step surface 107 can support the inner wall of the first heat generating member 41 or the second heat generating member 41, and the first step surface 108 can support the inner wall of the first heat conducting member 31 or the second heat conducting member 32. Both the first step surface 108 and the second step surface 107 are curved surfaces to fit the curved heat generating member 4 and the heat conducting member 3.

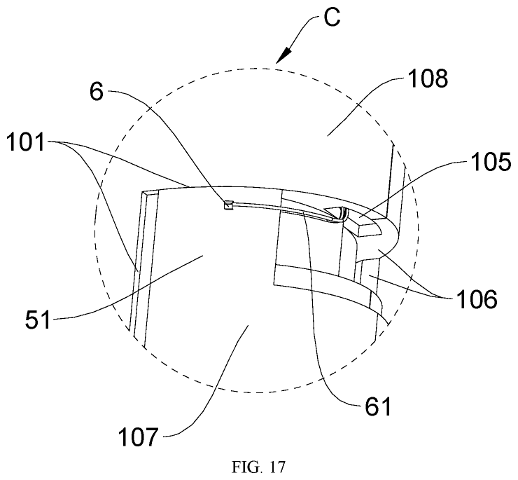

Preferably, the first step surface 108 or the second step surface 107 on the left and right sides of the front housing 11 and the back housing 12 includes a plurality of wiring holes 105 penetrating into the front housing 11 and the back housing 12. In the embodiment of the present disclosure, the plurality of wiring holes 105 is arranged at a connection between the first step surface 108, the first positioning window 101 and the second positioning window 102, as shown in FIG. 17, the wiring hole 105 passes through a wire 61 that the wire 61 connects the heating control circuit 2 with the first heat generating member 41 at the first positioning window 101 and the second heat generating member 42 at the second positioning window 102.

Furthermore, referring to FIG. 17, the second step surface 107 also includes a wire receiving room 106 arranged adjacent to the wiring hole 105 and configured to receive the wire 61 therein so as to avoid both the first heat generating member 41 and the second heat generating member 42 from being interfered by the wire 61.

Preferably, referring to FIG. 5 and FIG. 7, the second step surfaces 107 on the left and right sides of the front housing 11 and the back housing 12 are provided with high-temperature resistant foam 5, and inner surfaces of the first heat generating member 41 and the second heat generating member 42 are respectively pasted on corresponding high-temperature resistant foam 5. In the embodiment of the present disclosure, the high-temperature resistant foam 5 includes a first high-temperature resistant foam 51 and a second high-temperature resistant foam 52 respectively arranged on corresponding second step surfaces 107 on the left and, right sides of the front housing 11 and the back housing 12, and both the first high-temperature resistant foam 51 and the second high-temperature resistant foam 52 can be glued on both surfaces thereof. The first high-temperature resistant foam 51 is adhered to the second step surface 107 of the first positioning window 101 on the left side of the housing 1, and the second high-temperature resistant foam 52 is adhered to the second step surface 107 of the second positioning window 102 on the right side of the housing 1. The second step surface 107 is curved to fit and support the high-temperature resistant foam 5 well. An outer surface of the high-temperature resistant foam 5 is configured to paste and fix the heat generating member 4, so that the heat generating member 4 can be quickly installed and fixed at the first and second positioning windows 101, 102 of the housing 1. The high-temperature resistant foam 5 is made of high temperature resistant materials, such as EVA.

Preferably, referring to FIG. 16 and FIG. 17, the temperature sensor 6 of the hand warming device 100 of the present disclosure is pasted and fixed on the high-temperature resistant foam 5 and is in contact with the inner surfaces of the first heat generating member 41 and/or the second heat generating member 42. The temperature sensor 6 is electrically connected to the heating control circuit 2 through the wire 61 and is configured to sense a temperature of the first heat generating member 41 and/or the second heat generating member 42. When the temperature of the first heat generating member 41 and/or the second heat generating member 42 reaches a preset temperature, the heating control circuit 2 controls the first heat generating member 41 and the second heat generating member 42 to stop working to avoid to be overheated. When the temperature of the first heat generating member 41 and the second heat generating member 42 is lower than the preset temperature, the heating control circuit 2 controls the first heat generating member 41 and the second heat generating member 42 to start working, so that the temperature of the first heat generating member 41 and the second heat generating member 42 can be kept within a constant range.

In the conventional hand warming device, the temperature sensor 6 directly abuts against an aluminum shell of the heat conducting member 3, rather than being pasted and fixed, so that the temperature sensor 6 is easy to loosen and cause inaccurate temperature measurement. If the temperature measurement is inaccurate, it is easy to cause scalding and other incidents, which has potential safety hazards. The temperature sensor 6 of the present disclosure is directly fixed to the first high-temperature resistant foam 51 and/or the second high-temperature resistant foam 52 without being loosened. Inner walls of the heat generating member 4 and the high-temperature resistant foam 5 are firmly bonded, so that the temperature sensor 6 that has been fixed on the high-temperature resistant foam 5 can be firmly bonded to the heat generating member 4, so as to ensure accuracy of temperature measurement and improve safety of the product.

The hand warming device 100 in the embodiment of the present disclosure increases the contact area between a hand and the heat conducting member, improves the heating effect, and is convenient to hold the hand warming device by providing a left-right surrounding design of the heat generating member and the heat conducting member. At the same time, by providing the sliding engagement structure between the housing 1 and the heat conducting member 3, when the heat conducting member 3 is installed on the housing 1, the second sliding portion 33 of the heat conducting member 3 is slid into the first sliding portion 13 of the housing 1, so that the heat conducting member 3 can be installed on the housing 1 by a sliding and pushing manner, which is convenient and fast. In addition, the present disclosure adopts a sliding installation and disassembly of the heat conducting member 3, which is easy to disassemble and repair the heat conducting member 3. In the embodiment of the present disclosure, the first and second positioning windows are arranged on the housing 1, which can accurately and quickly position and install the heat generating member 4, furthermore, the temperature sensor 6 is directly fixed on the high-temperature resistant foam 5, so that the temperature sensor 6 can be firmly attached to the heat generating member 4, which can ensure the accuracy of temperature measurement and improve the safety of the product.

Although the features and members of the present disclosure are described as embodiments in particular combinations, each feature or member can be used alone or in other various combinations within the principles of the present disclosure to the full extent indicated by the broad general meaning of the terms in which the appended claims are expressed.

What is claimed is:

1. A hand warming device comprising:
a housing comprising a front housing and a back housing connected with the front housing;
wherein a side of the front housing and the back housing along a length direction of the housing is a right side, and a left side opposite to the right side;
a heating control circuit received in the housing;
a heat conducting member surrounding around an outer surface of the housing; a heat generating member clamped between the housing and the heat conducting member, and horizontally wrapped on the right side of the front housing and the back housing and/or horizontally wrapped on the left side of the front housing and the back housing;
a temperature sensor, both the heat generating member and the temperature sensor electrically connected to the heating control circuit; and wherein
the heat conducting member is horizontally wrapped on the right side of the front housing and the back housing and/or horizontally wrapped on the left side of the front housing and the back housing, and when the heat conducting member is arranged on the front housing and the back housing, the heat conducting member covers on the heat generating member and abuts against the heat generating member.

2. The hand warming device as claimed in claim 1, wherein the heat generating member comprises a first heat generating member and a second heat generating member, the first heat generating member horizontally surrounding the left side of the front housing and the back housing and spanning a left connection of the front housing and the back housing, and the second heat generating member horizontally surrounding the right side of the front housing and the back housing and spanning a right connection of the front housing and the back housing;
correspondingly, the heat conducting member comprising a first heat conducting member and a second heat conducting member, the first heat conducting member horizontally surrounding the left side of the front housing and the back housing and spanning the left connection of the front housing and the back housing, and the second heat conducting member horizontally surrounding the right side of the front housing and the back housing and spanning the right connection of the front housing and the back housing, the first heat conducting member covering on the first heat generating member and abutting against the first heat generating member, and the second heat conducting member covering on the second heat generating member and abutting against the second heat generating member.

3. The hand warming device as claimed in claim 2, wherein a first positioning window horizontally surrounds from the left side of the front housing to the left side of the back housing, and a second positioning window horizontally surrounding from the right side of the front housing to the right side of the back housing, the first heat generating member mounted on the first positioning window, and the second heat generating member mounted on the second positioning window.

4. The hand warming device as claimed in claim 3, wherein a third positioning window is arranged on an area that both the front housing and the back housing cover on the first positioning window, a fourth positioning window arranged on an area that both the front housing and the back housing cover on the second positioning window, the first heat conducting member installed in the third positioning window to cover on the first positioning window, and the second heat conducting member installed in the fourth positioning window to cover on the second positioning window.

5. The hand warming device as claimed in claim 4, wherein when the first heat conducting member is installed in the third positioning window, an outer surface of the first heat conducting member is flush with an outer surface of the front housing and an outer surface of the back housing, and when the second heat conducting member is installed in the fourth positioning window, an outer surface of the second heat conducting member is flush with the outer surface of the front housing and the outer surface of the back housing.

6. The hand warming device as claimed in claim 2, wherein each of the front housing and the back housing comprises a first sliding portion, and each of the first heat conducting member and the second heat conducting member comprises a second sliding portion; and wherein the first sliding portion is slidably engaged with the second sliding portion, so that both the first heat conducting member and the second heat conducting member are slidably pushed into the front housing and the back housing or slid out of the front housing and the back housing.

7. The hand warming device as claimed in claim 6, wherein the first sliding portion is a sliding groove arranged on the front housing and the back housing, the second sliding portion is a protrusion arranged on the first heat conducting member and the second heat conducting member, and sliding in the sliding groove after the protrusion is engaged with the sliding groove.

8. The hand warming device as claimed in claim 7, wherein the sliding groove comprises a positioning groove with a horn shape arranged at a position where the protrusion slides in.

9. The hand warming device as claimed in claim 1, wherein the heat conducting member is made of aluminum.

10. The hand warming device as claimed in claim 1, wherein the heat generating member is made of a sheet-shaped flexible material.

11. The hand warming device as claimed in claim 10, wherein the heat generating member is a PI flexible electrothermal film.

12. The hand warming device as claimed in claim 4, wherein the third positioning window and the fourth positioning window are respectively recessed on the outer surface at the left side of the front housing and the outer surface at the right side of the back housing to form a first step surface, while each of the first positioning window and the second positioning window is recessed to form a second step surface corresponding to the first step surface.

13. The hand warming device as claimed in claim 12, wherein the first step surface or the second step surface on the left and right sides of the front housing and the back housing comprises a plurality of wiring holes penetrating into the front housing and the back housing.

14. The hand warming device as claimed in claim 12, wherein the second step surfaces on the left and right sides of the front housing and the back housing are provided with high-temperature resistant foam, and inner surfaces of the first heat generating member and the second heat generating member are respectively pasted on corresponding high-temperature resistant foam.

15. The hand warming device as claimed in claim 14, wherein the temperature sensor is pasted on the high-temperature resistant foam and is in contact with the inner surfaces of the first heat generating member and/or the inner surface of the second heat generating member.

16. The hand warming device as claimed in claim 1, wherein the housing is further provided with a charging interface electrically connected with the heating control circuit.

17. The hand warming device as claimed in claim 1, wherein the housing is further provided with a control switch electrically connected with the heating control circuit.

18. The hand warming device as claimed in claim 1, wherein the housing is further provided with an LED signal lamp electrically connected with the heating control circuit.
